(19) United States
(12) Patent Application Publication
(10) Pub. No.: US 2019/0204679 A1
(43) Pub. Date: Jul. 4, 2019

(54) LIQUID CRYSTAL DISPLAY DEVICE

(71) Applicant: Polatechno Co., Ltd., Nigata (JP)

(72) Inventor: Norio KOMA, Niigata (JP)

(73) Assignee: Polatechno Co., Ltd., Nigata (JP)

(21) Appl. No.: 15/772,717

(22) PCT Filed: Oct. 24, 2016
(86) PCT No.: PCT/JP2016/081433

§ 371 Date: May 1, 2018

(30) Foreign Application Priority Data
Nov. 27, 2015 (JP) 2015-231337

(51) Int. Cl. G02F 1/1335; G02F 1/1368

(52) U.S. Cl. CPC G02F 1/133602; G02F 1/1368; G02F 1/133621; G02F 1/133528

(57) ABSTRACT

This liquid crystal display device is configured such that: a polarizing plate having a polarizer for polarizing light is arranged between the substrate of a TFT substrate and a counter substrate; the polarizing plate is provided with a dye polarizer that uses a dichromatic dye; and a wavelength conversion layer for converting the wavelength of light is arranged on the outer side of the polarizing plate when viewed from a liquid crystal layer.

### TECHNICAL FIELD

The present disclosure relates to a liquid crystal display.

### BACKGROUND

A typical liquid crystal display is a non-light emissive display, and realizes a color display by optically modulating, in a liquid layer and for each pixel, light from a backlight having a white LED or the like as a light source, and allowing the light to transmit through color filters of red (R), green (G), and blue (B). Characteristics of the white LED include high light emission efficiency is high and long lifetime. On the other hand, the white LED has a large light loss due to reduction of the light emission efficiency of a fluorescent substance due to heat (so-called thermal quenching). Further, because the structure separates the light from the white LED into red, green, and blue colors by the color filter layers, light of only ⅓ of the backlight is actually used, and the light usage efficiency for the liquid crystal display as a whole is low.

There are also disclosed liquid crystal displays in which an ultraviolet light source is used as the backlight, and fluorescent substance layers of the colors of red, green, and blue are caused to emit light using the ultraviolet light source as excitation light. Further, there are disclosed liquid crystal displays in which a blue LED is used as the backlight, blue light which is output from the blue LED is used to cause red and green fluorescent substance layers to emit light and to consequently obtain red and green lights, and the blue light from the blue LED is transmitted to display the blue light.

In addition, there is disclosed a liquid crystal display which comprises a pair of substrates sandwiching a liquid crystal layer, a light emitting diode which is placed on a back surface of one of the pair of substrates and that emits light in a range of a peak wavelength of 380 nm˜420 nm, and a polarization plate formed on the other of the pair of substrate, wherein a subpixel is provided in each unit pixel on a side, of the polarization plate formed on the other of the pair of the substrates, opposite from the liquid crystal layer, the subpixel comprising a fluorescent substance layer which absorbs light in the range of the peak wavelength of 380 nm˜420 nm and which emits light of a predetermined color, and a filter layer is formed on a surface, of the fluorescent substance layer, opposite from the liquid crystal layer, which reflects or absorbs light of a wavelength of 420 nm or shorter.

### SUMMARY

### Technical Problem

By providing a wavelength conversion layer such as the fluorescent substance layer which converts a wavelength of incident light and outputs output light of a different wavelength, it becomes possible to improve the usage efficiency of the light from the backlight. However, when a spacing between the wavelength conversion layer and the display electrode is wide, it is necessary to set a wide distance also between the pixels, in order to avoid color mixing between pixels. Therefore, it is difficult to provide a display of high resolution.

### Solution to Problem

According to one aspect of the present disclosure, there is provided a liquid crystal display in which a liquid crystal layer is sandwiched between two substrates, the liquid crystal display comprising: a polarization element that polarizes light, provided between the two substrates, wherein the polarization element is a dye-based polarization element which uses a dichroic dye; and a wavelength conversion layer that converts a wavelength of light, provided at an outer side with respect to the polarization element, viewed from the liquid crystal layer.

### Advantageous Effects of Invention

According to the present disclosure, the light usage efficiency of the liquid crystal display can be improved, a spacing between the wavelength conversion layer and the polarization element can be narrowed, and a high resolution can be provided.

### BRIEF DESCRIPTION OF DRAWINGS

FIG. 1 is a cross sectional schematic diagram showing a structure of a liquid crystal display according to a first embodiment of the present disclosure.

FIG. 2 is a cross sectional schematic diagram showing a structure of a liquid crystal display according to a second embodiment of the present disclosure.

### DESCRIPTION OF EMBODIMENTS

### First Embodiment

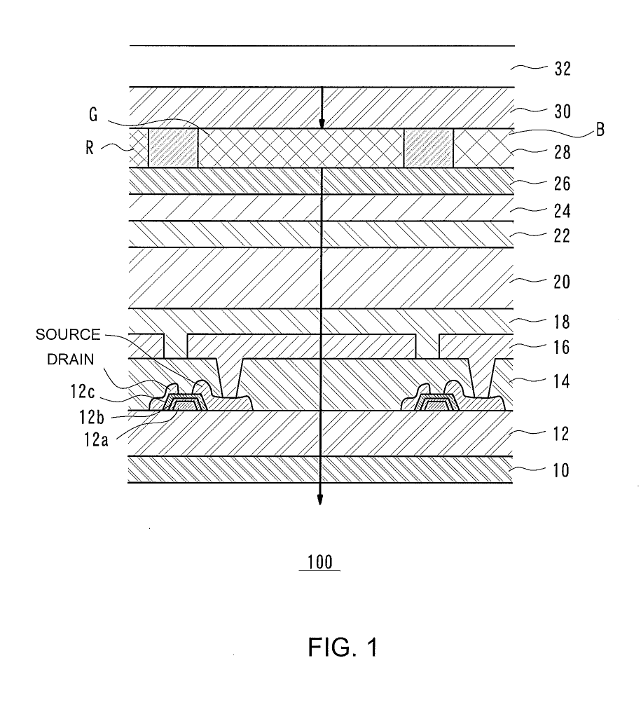

As show in a cross sectional schematic diagram of FIG. 1, a liquid crystal display 100 according to a first embodiment of the present disclosure comprises a polarization layer 10, a TFT substrate 12, an interlayer insulating film 14, a display electrode 16, an orientation film 18, a liquid crystal layer 20, an orientation film 22, an opposing electrode 24, a polarization plate (polarization layer) 26, a wavelength conversion layer 28, an opposing substrate 30, and a backlight 32. The liquid crystal display 100 functions as a device that displays an image by receiving light from the backlight 32 and outputting light having the wavelength converted by the wavelength conversion layer 28, from the side of the polarization layer 10, as shown by an arrow. FIG. 1 is a schematic diagram, and sizes and thicknesses of the constituting elements do not reflect the actual values.

In the present embodiment, an active matrix type liquid crystal display is exemplified as the liquid crystal display 100, but the application of the present disclosure is not limited to such a configuration, and the present disclosure may be applied to liquid crystal displays of other forms such as a passive matrix type.

The TFT substrate 12 is formed by placing TFTs for each pixel over a substrate. The substrate is a transparent substrate such as glass. The substrate mechanically supports the liquid crystal display 100, and is used to display an image by allowing light to transmit therethrough. The substrate may alternatively be a flexible substrate made of a resin such as an epoxy resin, a polyimide resin, an acrylic resin, a polycarbonate resin, or the like.

In FIG. 1, two TFTs are shown. At a lower side (on the substrate) on an approximate center of the TFT, a gate electrode 12a which is connected to a gate line is placed. A gate insulating film 12b is formed covering the gate electrode 12a, and a semiconductor layer 12c is formed covering the gate insulating film 12b. The gate insulating film 12b is formed from, for example, an insulator such as SiO₂. The semiconductor layer 12c is formed from amorphous silicon or polycrystalline silicon, a portion immediately above the gate electrode 12a is set as a channel region in which almost no impurity exists, and the respective sides thereof are set as a source region and a drain region to which conductivity is added by doping of impurities. A contact hole is formed over the drain region of the TFT, a drain electrode made of a metal (for example, aluminum) is placed (electrically connected) in the contact hole, a contact hole is formed over the source region, and a source electrode made of a metal (for example, aluminum) is placed (electrically connected) in the contact hole. The drain electrode is connected to a data line to which a data voltage is supplied.

Over a surface, of the TFT substrate 12, on the side on which the TFT is not formed, the polarization layer 10 is formed. The polarization layer 10 is formed covering the surface of the substrate of the TFT substrate 12. The polarization layer 10 is desirably a layer in which a dye-based polarization element dyed by an iodine-based material or a dichroic dye is contained in a PVA (polyvinyl alcohol)-based resin. Alternatively, the polarization layer 10 may be formed after the orientation film 18 is formed.

Over a surface of the TFT substrate 12 on the side on which the TFT is formed, the display electrode 16 is provided with the interlayer insulating film 14 therebetween. The display electrode 16 is an individual electrode separated for each pixel, and is a transparent electrode made by, for example, ITO (Indium Tin Oxide). The display electrode 16 is connected to the source electrode formed in the TFT substrate 12.

The orientation film 18 is formed covering the display electrode 16. The orientation film 18 is formed from a resin material such as polyimide. The orientation film 18 can be formed, for example, by printing a solution of 5 wt % of N-methyl-2-pyrrolidinone which becomes the polyimide resin over the display electrode 16, curing by heating at a temperature of about 180° C. to about 280° C., and rubbing with a rubbing cloth to apply an orientation process.

Next, a structure and a manufacturing method of the side of the opposing substrate 30 will be described. The opposing substrate 30 is a transparent substrate such as glass or the like. The opposing substrate 30 mechanically supports the liquid crystal display 100, and is used to allow light from the backlight 32 to transmit therethrough and enter the wavelength conversion layer 28 or the like. The opposing substrate 30 may alternatively be a flexible substrate made of a resin such as the epoxy resin, the polyimide resin, the acrylic resin, and the polycarbonate resin, or the like.

The wavelength conversion layer 28 is formed over the opposing substrate 30. The wavelength conversion layer 28 is placed in a matrix form in an in-plane direction of the opposing substrate 30 for each pixel. As the wavelength conversion layer 28, there may be applied any fluorescent substance which receives light from the backlight 32 and which emits light of a particular wavelength region, as will be described later. The fluorescent substance is desirably a material which emits light of one of red (R), green (G), and blue (B) for each pixel. An Eu-activated sulfide-based red fluorescent substance may be used for a red fluorescent substance, an Eu-activated sulfide-based green fluorescent substance may be used for a green fluorescent substance, and an Eu-activated phosphate-based blue fluorescent substance may be used for a blue fluorescent substance. The wavelength conversion layer 28 includes one or a plurality of fluorescent substances according to a color to be displayed.

For example, when two fluorescent substances which absorb light from the backlight 32 in a range of longer than or equal to 380 nm and shorter than or equal to 420 nm and which emit blue light and yellow light are included, a white light may be simulated. Similarly, when three fluorescent substances which emit red light, green light, and blue light are included, white light can be obtained. Furthermore, by suitably selecting and using one or a plurality of the fluorescent substances which absorb the light from the backlight 32 having the peak wavelength in the range of longer than or equal to 380 nm and shorter than or equal to 420 nm, and which emit light of an arbitrary color, it is possible to obtain a liquid crystal display which can emit light of an arbitrary color.

Alternatively, for example, when two fluorescent substances which absorb light from the backlight 32 in the wavelength range of the ultraviolet ray of shorter than or equal to 380 nm and which emit blue light and yellow light of predetermined wavelength regions are included, white light can be simulated. Similarly, when three fluorescent substances which emit light of red light, green light, and blue light are included, white light can be obtained. Moreover, by suitably selecting and using one or a plurality of fluorescent substances which absorb the light from the backlight 32 having the peak wavelength in the range of shorter than or equal to 380 nm and which emit light of an arbitrary color, it is possible to obtain a liquid crystal display which can emit light of an arbitrary color.

Alternatively, the wavelength conversion layer 28 may be realized by a quantum dot structure in which a plurality of semiconductor materials having different characteristics are periodically placed. The quantum dot is a structure in which semiconductor materials having different bandgaps are repeatedly placed in a period of a nm order, to make the structure function as the material having a desired bandgap. The quantum dot may be used as the wavelength conversion layer 28 which receives the light from the backlight 32 and which emits light of a wavelength region corresponding to the bandgap. Specifically, there is formed a quantum dot structure having a characteristic in which the light of the wavelength region of the output light of the backlight 32 is absorbed, and light of one of red (R), green (G), and blue (B) is emitted.

The polarization plate 26 is formed over the wavelength conversion layer 28. The polarization plate 26 is desirably a plate in which a dye-based polarization element dyed by a dichroic dye is contained in a PVA (polyvinyl alcohol)-based resin. Here, the dye-based material desirably contains an azo compound and/or a salt of the azo compound.

More specifically, it is desirable to use a dye-based material satisfying the following chemical formula.

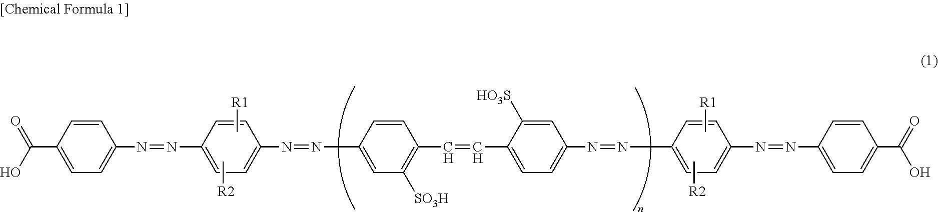

That is, the dye-based material may be: (1) an azo compound or a salt thereof in which, in the Formula, each of R1 and R2 is independently a hydrogen atom, a lower alkyl group, or a lower alkoxyl group, and n is 1 or 2; (2) an azo compound or a salt thereof described in (1) in which each of R1 and R2 is independently one of a hydrogen atom, a methyl group, and a methoxy group; or (3) an azo compound or a salt thereof described in (1) in which R1 and R2 are hydrogen atoms.

For example, a material obtained by the following process is desirable. 13.7 parts of 4-aminobenzoic acid is added to 500 parts of water, and dissolved by sodium hydroxide. The obtained substance is cooled, 32 parts of 35% hydrochloric acid is added at a temperature lower than or equal to 10° C., 6.9 parts of sodium sulfite is then added, and the product is stirred for 1 hour at a temperature of 5˜10° C. 20.9 parts of aniline-w-sodium methanesulfonic acid is added, and while stirring at a temperature of 20˜30° C., sodium carbonate is added to adjust the pH to 3.5. The product is further stirred to complete a coupling reaction, and filtered, to obtain a monoazo compound. The obtained monoazo compound is stirred at a temperature of 90° C. under presence of sodium hydroxide, to obtain 17 parts of a monoazo compound of Chemical Formula (2).

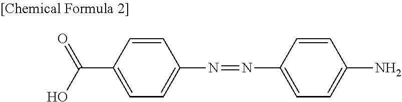 [SMILES: Nc1ccc(N=Nc2ccc(C(=O)O)cc2)cc1]

After 12 parts of the monoazo compound of Chemical Formula (2) and 21 parts of 4,4′-dinitrostilbene-2,2′-sulfonic acid are dissolved in 300 parts of water, 12 parts of sodium hydroxide are added, and a condensation reaction is caused at a temperature of 90° C. Then, after the product is reduced with 9 parts of glucose, and salted out by sodium chloride, the product is filtered, to obtain 16 parts of an azo compound represented by Chemical Formula (3).

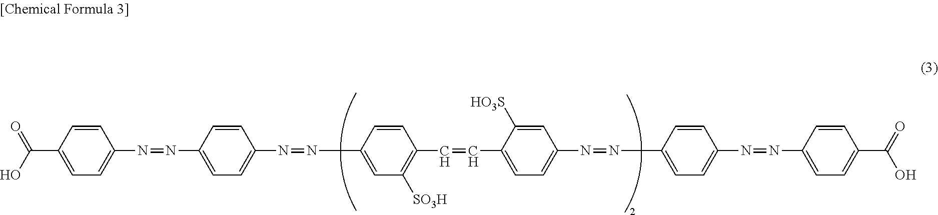

Further, polyvinyl alcohol (PVA) having a thickness of 75 μm is immersed for 4 minutes as the substrate 20a in an aqueous solution of 45° C. and having concentrations of 0.01% of the dye of Chemical Formula (3), 0.01% of C.I. Direct Red 81, 0.03% of a dye shown in Example 1 of JP 2622748 B and represented by the following Chemical Formula (4), 0.03% of a dye shown in Example 23 of JP S60-156759 A and represented by the following Chemical Formula (5), and 0.1% of Glauber's salt. The film is stretched to a 5-times length at 50° C. in an aqueous solution of 3% boric acid, and is washed by water and dried while maintaining a tensioned state. With this process, a dye-based material having a neutral color (gray in a parallel orientation, and black in a perpendicular orientation) can be obtained.

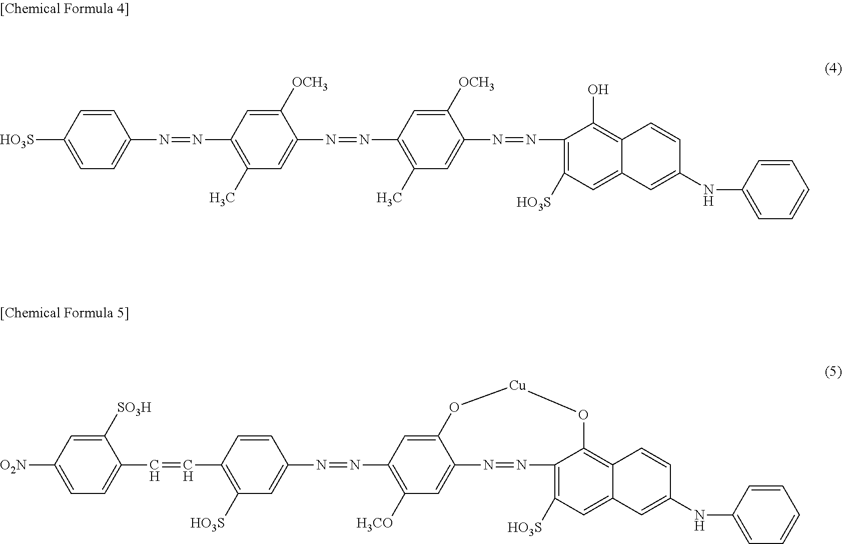

A polarization element which is normally used is an iodine-based polarization element formed by a material in which a resin is dyed by iodine and an iodine compound. However, iodine and the iodine compound are weak against heat, and the characteristics thereof are modified by heating at a temperature of about 100° C. On the other hand, the polarization element which uses the dye (dichroic dye) is relatively strong with respect to heat, and the change in the characteristic can be prevented with heating at a temperature of about 130° C. Thus, the polarization plate 26 can be formed between the opposing substrate 30 and the orientation film 22 without being affected by the film formation temperatures during the formations of the orientation film 22 and the opposing electrode 24, to be described later.

The opposing electrode 24 is formed over the polarization plate 26. The opposing electrode 24 is, for example, a transparent electrode formed by ITO (Indium Tin Oxide) or the like.

The orientation film 22 is formed over the opposing electrode 24. The orientation film 22 is formed from a resin material such as the polyimide. The orientation film 22 is formed, for example, by printing a solution f 5 wt % of N-methyl-2-pyrrolidinone which becomes the polyimide resin over the opposing electrode 24, curing by heating at a temperature of about 110° C. to about 280° C., and rubbing by a rubbing cloth to apply the orientation process. An orientation direction of the orientation film 22 is set at a direction orthogonal to an orientation direction of the orientation film 18.

In this process, alternatively, a light orientation film may be used. With the use of the light orientation film, a low-temperature process of lower than or equal to 130° C. can be easily executed. In particular, when the IPS type structure is used, a pre-tilt can be reduced, and thus, such a configuration is convenient.

The orientation film 18 and the orientation film 22 are placed to face each other, and the liquid crystal layer 20 is sealed between the orientation film 18 and the orientation film 22. A spacer (not shown) is inserted between the orientation film 18 and the orientation film 22, liquid crystal is filled between the orientation film 18 and the orientation film 22, and a periphery thereof is sealed by a sealing member (not shown), to form the liquid crystal layer 20.

In the liquid crystal layer 20, the orientation is controlled by the orientation film 18 and the orientation film 22, and an initial orientation state (at the time of no application of electric field) of the liquid crystal of the liquid crystal layer 20 is determined by the orientation film 18 and the orientation film 22. A voltage is applied between the display electrode 16 and the opposing electrode 24, to generate an electric field between the display electrode 16 and the opposing electrode 24, thereby controlling the orientation of the liquid crystal layer 20, and in turn controlling transmission/non-transmission of the light.

The backlight 32 is formed including a light source which outputs light. The light source is desirably, for example, an LED. A wavelength of the light which is output from the backlight 32 is desirably in the wavelength region which can be effectively used for the wavelength conversion at the wavelength conversion layer 28. For example, the backlight 32 is desirably a light source which emits light in a wavelength region having the peak wavelength of longer than or equal to 380 nm and shorter than or equal to 420 nm, or a light source which emits light in a wavelength region of shorter than or equal to 380 nm.

According to the liquid crystal display 100, the light from the backlight 32 can be wavelength-converted by the wavelength conversion layer 28 and used, so that the usage efficiency of the light can be improved. With this improvement, the energy efficiency in the liquid crystal display 100 can also be improved, and a low-power-consumption liquid crystal display 100 can be realized. By applying the semiconductor layer of the quantum dot structure as the wavelength conversion layer 28, it becomes possible to further reduce the power consumption as compared to the case where the fluorescent substance is used.

By employing an in-cell type structure in which the polarization plate 26 is formed between the opposing substrate 30 and the liquid crystal layer 20, it becomes possible to provide the wavelength conversion layer 28 also between the opposing substrate 30 and the liquid crystal layer 20, and the distance between the light emitting substance and the display electrode 16 and the TFT substrate 12 can be made closer as compared to the related art. For example, the opposing substrate 30 has a thickness of about 500 μm, and compared to the structure where the polarization plate 26 is formed between the opposing substrate 30 and the backlight 32, the wavelength conversion layer 28 can be set closer to the display electrode 16 and the TFT substrate 12 by the thickness of the opposing substrate 30. With such a configuration, it becomes possible to reduce a margin for the distance between pixels in order to avoid color mixing between the pixels. Therefore, a high-resolution liquid crystal display 100 can be provided.

Further, by using a material which transmits light in the wavelength region of shorter than or equal to 380 nm for the polarization layer 10, it is possible to improve visibility outdoors.

### Second Embodiment

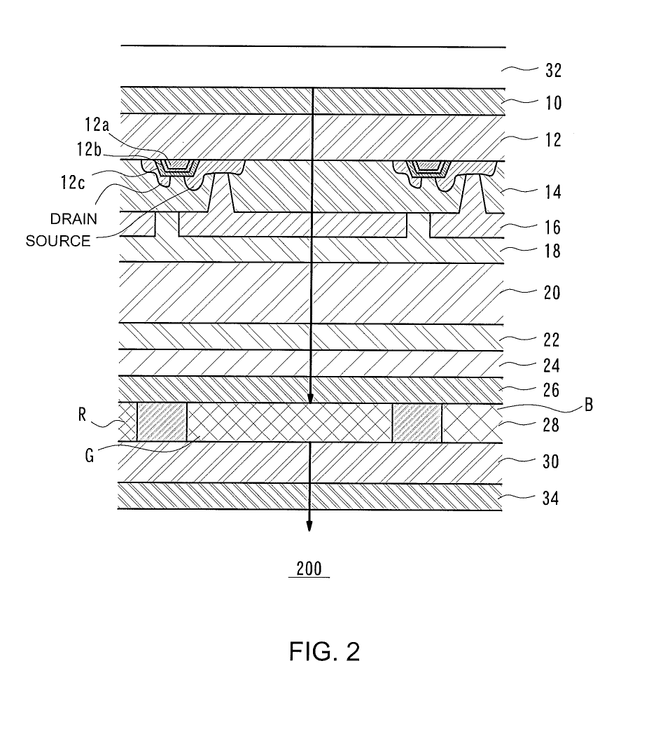

As shown in a cross sectional schematic diagram of FIG. 2, a liquid crystal display 200 according to the present embodiment has a structure in which the backlight 32 is provided on the side of the opposing substrate 30, and the opposing substrate 30 is set as the output side. Specifically, the liquid crystal display 200 is a device in which, as shown by an arrow, light from the backlight 32 is received, control of the transmission/non-transmission is applied by the liquid crystal layer 20 or the like, the wavelength of the light is converted by the wavelength conversion layer 28, and the light is output from the side of the polarization layer 10, to display an image. FIG. 2 is a schematic diagram, and the sizes and thicknesses of the constituting elements do not reflect the actual values.

In the liquid crystal display 200, the structures from the polarization layer 10 to the opposing substrate 30 can be formed in a manner similar to that in the first embodiment, and thus, the processes will not be described again.

In the liquid crystal display 200, a cut filter 34 is desirably provided on a surface on the outer side of the opposing substrate 30. The cut filter 34 is a filter which blocks light of a wavelength region which is affected by the wavelength conversion in the wavelength conversion layer 28. More specifically, the cut filter 34 is desirably a filter that blocks light in a wavelength region of shorter than or equal to 420 nm.

According to the liquid crystal display 200, by wavelength-converting the light from the backlight 32 at the wavelength conversion layer 28 and using the converted light, the usage efficiency of the light can be improved. With this advantage, the energy efficiency in the liquid crystal display 200 can also be improved, and a low-power consumption liquid crystal display 200 can be realized. Further, by applying the semiconductor layer of the quantum dot structure for the wavelength conversion layer 28, the power consumption can further be reduced as compared to the case where the fluorescent substance is used. In addition, in the liquid crystal display 200, a display characteristic close to a light emissive type display can be obtained. Moreover, in the liquid crystal display 200, a viewing angle dependency can be reduced.

By employing the in-cell structure in which the polarization plate 26 is formed between the opposing substrate 30 and the liquid crystal layer 20, it becomes possible to provide the wavelength conversion layer 28 also between the opposing substrate 30 and the liquid crystal layer 20, and the distance between the light emitting substance and the display electrode 16 and the TFT substrate 12 can be set closer as compared to the related art. With such a configuration, it becomes possible to reduce the margin in the distance between the pixels in order to avoid color mixing between the pixels. Therefore, a high-resolution liquid crystal display 200 can be provided.

Further, by providing the cut filter 34, the visibility outdoors can be improved.

In addition, for the polarization plate 26 of the second embodiment, there may be used a dye-based polarization layer which is made of a dichroic dye which can polarize light of a short wavelength according to a light emission spectrum of the light source which is used, for example, a single, orange-based colorant O-2GL, so that a high polarization characteristic can be realized as compared to a dye-based polarization layer of a mixed system, and a high contrast display can be realized. The same is true for the polarization layer 10.

### REFERENCE SIGNS LIST

10 POLARIZATION LAYER; 12 TFT SUBSTRATE; 12a GATE ELECTRODE; 12b GATE INSULATION FILM; 12c SEMICONDUCTOR LAYER; 14 INTERLAYER INSULATING FILM; 16 DISPLAY ELECTRODE; 18 ORIENTATION FILM; 20 LIQUID CRYSTAL LAYER; 22 ORIENTATION FILM; 24 OPPOSING ELECTRODE; 26 POLARIZATION PLATE; 28 WAVELENGTH CONVERSION LAYER; 30 OPPOSING SUBSTRATE; 32 BACKLIGHT; 34 CUT FILTER; 100, 200 LIQUID CRYSTAL DISPLAY.

1. A liquid crystal display in which a liquid crystal layer is sandwiched between two substrates, the liquid crystal display comprising:
a polarization element that polarizes light, provided between the two substrates, wherein the polarization element is a polarization element which uses a dichroic dye; and
a wavelength conversion layer that converts a wavelength of light, provided at an outer side with respect to the polarization element, viewed from the liquid crystal layer.

2. The liquid crystal display according to claim 1, wherein
a distance between the polarization element and the wavelength conversion layer is smaller than or equal to 100 μm.

3. The liquid crystal display according to claim 1, wherein
the wavelength conversion layer includes a fluorescent substance.

4. The liquid crystal display according to claim 1, wherein
the wavelength conversion layer includes a quantum dot.

5. The liquid crystal display according to claim 1, wherein
the wavelength conversion layer converts light into wavelength regions of red, green, and blue.

6. The liquid crystal display according to claim 1, wherein
the wavelength conversion layer is provided between a light output unit and the polarization element.

7. The liquid crystal display according to claim 1, wherein
the polarization element is provided between a light output unit and the wavelength conversion layer.

8. The liquid crystal display according to claim 1, wherein
the wavelength conversion layer converts light in a wavelength range of longer than or equal to 380 nm and shorter than or equal to 420 nm.

9. The liquid crystal display according to claim 1, wherein
the wavelength conversion layer converts light in a wavelength region of shorter than or equal to 380 nm.
